(19) United States
(12) Patent Application Publication
(10) Pub. No.: US 2004/0105467 A1
(43) Pub. Date: Jun. 3, 2004

(54) System and method for 10baset ethernet communication over a single twisted pair utilizing internal power sources

(75) Inventor: David D. Goodman, Arlington, VA (US)

Correspondence Address: HALE & DORR LLP, THE WILLARD OFFICE BUILDING, 1455 PENNSYLVANIA AVE, NW, WASHINGTON, DC, 20004, US

(73) Assignee: Inline Connection Corporation, Arlington, VA

(21) Appl. No.: 10/660,797

(22) Filed: Sep. 12, 2003

Related U.S. Application Data
(60) Provisional application No. 60/410,006, filed on Sep. 12, 2002.
(60) Provisional application No. 60/479,912, filed on Jun. 20, 2003.
(60) Provisional application No. 60/496,991, filed on Aug. 22, 2003.

(51) Int. Cl. H04L 12/28; H04L 12/56

(52) U.S. Cl. 370/910

(57) ABSTRACT

The present invention relates generally to a system and method that allows multiple computers, optionally separated by a distance greater than specified in the IEEE 802.3 standard, to utilize an existing wiring infrastructure to obtain a high speed connection to a network such as the Internet.

### CROSS-REFERENCE TO RELATED APPLICATIONS

This application claims the benefit of U.S. Provisional Application No. 60/410,006, filed Sep. 12, 2002, U.S. Provisional Application No. 60/479,912, filed Jun. 20, 2003, and U.S. Provisional Application No. 60/496,991 filed Aug. 22, 2003, each of which are incorporated herein by reference.

### BACKGROUND OF THE INVENTION

1. Field of the Invention

The present invention relates generally to a system and method for providing an extended Ethernet data network and, more particularly, to a system and method that provides an extended Ethernet data network in a cost effective manner by utilizing an existing wiring infrastructure.

2. Background Description

As disclosed in U.S. Pat. No. 6,192,399, entitled Twisted Pair Communication System, which is incorporated herein by reference, virtually all modern day commercial buildings, such as hotels, have an existing telephone wiring network. However, such buildings may not have a data wiring network that provides a connection from, for example, a wiring closet to guest rooms. Moreover, because of the expense associated with installing wiring associated with a data network in existing buildings, financial considerations often preclude the installation of such wiring. Accordingly, there exists a need to provide data services in such buildings, in a cost effective manner.

### SUMMARY OF THE INVENTION

The present invention provides a system and method that enables two devices to communicate over a transmission line using, for example, a 10BaseT Ethernet system in accordance with the Institute of Electrical and Electronic Engineers (IEEE) 802.3 Ethernet standard (hereinafter the Ethernet standard). The transmission line may be a single twisted pair, rather than two pairs, as is specified in the Ethernet standard. The transmission line may optionally be in use as a conductive path for telephone communication. Additionally, the length of the transmission line may advantageously be approximately twice as long as the maximum length defined by the Ethernet standard. Finally, the transmission line may include at least one split.

At least one embodiment of the present invention includes two electronic adaptors, each of which connects between the transmission line and a different one of two digital devices. Neither of the adapters substantially alters the Ethernet waveforms generated by the two digital devices, except for optionally adjusting the signal level and the signal tilt. As a result, the adapters are relatively simple electronically, and can be built on a relatively small circuit boards. This simplicity, moreover, allows one of the adapters to operate without the use of an external power supply even though it performs active processing.

The system can also be advantageously utilized when there may be one or more disadvantages associated with using a relatively large electronic adaptor and/or power from a 120V or 220V AC outlet (e.g., poor aesthetics and/or being subject to disconnection). One situation that typically presents these conditions is that of connecting hotel guest rooms to a point in the wiring closet to provide a high-speed Internet access connection.

A system and method in accordance with one or more embodiments of the present invention allows multiple computers, equipped with standard Ethernet connection electronics such as a standard Network Interface Card (NIC), to utilize an existing wiring infrastructure to obtain a high speed connection to a network such as the Internet.

Before explaining at least some embodiments of the invention in detail, it is to be understood that the invention is not limited in its application to the details of construction and to the arrangements of the components set forth in the following description or illustrated in the drawings. The invention is capable of other embodiments and of being practiced and carried out in various ways.

### BRIEF DESCRIPTION OF THE DRAWINGS

The Detailed Description including the description of preferred structures as embodying features of the invention will be best understood when read in reference to the accompanying figures wherein:

FIG. 1 is an exemplary simplified block diagram of a system of the present invention, which also illustrates an overview of a method according to the present invention;

FIG. 2 is an exemplary embodiment of a block diagram of circuitry that can be used in connection with a network Ethernet switch;

FIG. 3 is an exemplary embodiment of a block diagram of circuitry that can be used in connection with a network computing device;

FIG. 4 is an alternate exemplary embodiment of a block diagram of circuitry that can be used in connection with a network Ethernet switch; and

FIG. 5 is an alternate exemplary embodiment a block diagram of circuitry that can be used in connection with a network computing device.

### DETAILED DESCRIPTION OF A PREFERRED EMBODIMENT OF THE INVENTION

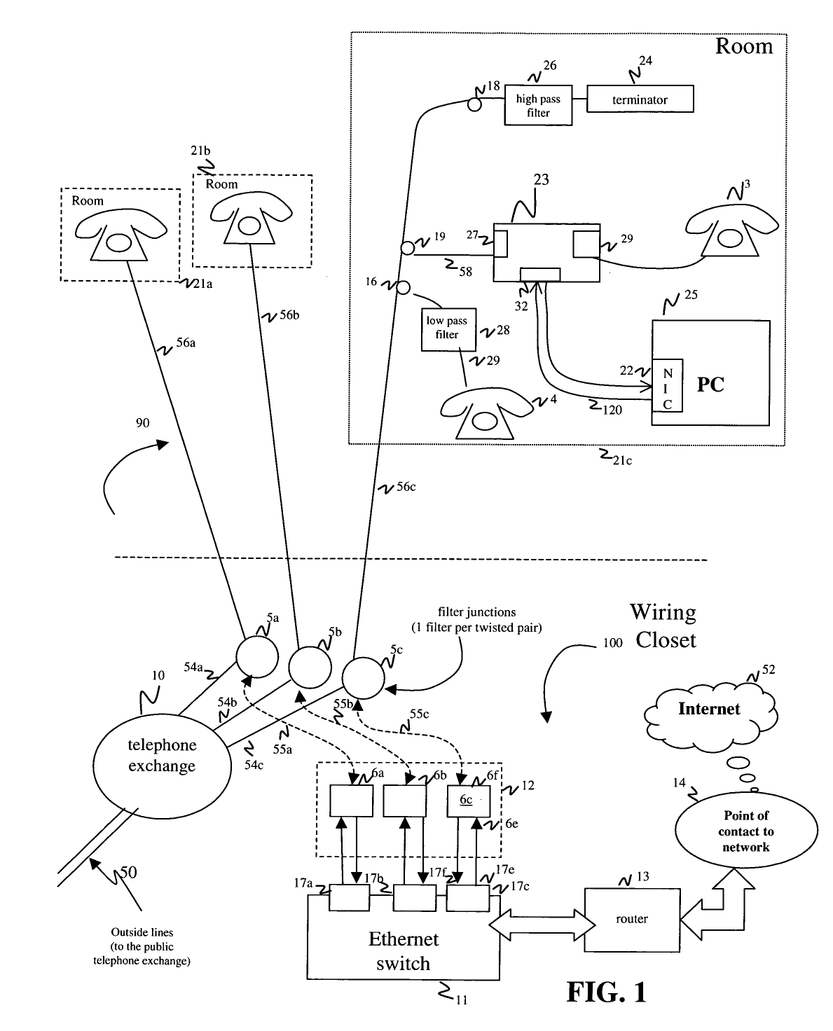

FIG. 1 is an exemplary embodiment of the present invention showing the main components of the system, generally at 90, that utilizes active telephone wiring to provide a data network that can be utilized by or accessed by, for example, a personal computer (PC) 25. Insofar as system 90 can be extended to any number of rooms, PC 25 (or equivalent, such as a laptop computer) and the configuration shown in room 21c can also be used in rooms 21a, 21b and/or other rooms (not shown). A Network Interface Connector (NIC) 22 is used in conjunction with PC 25 to facilitate connecting the PC 25 to system 90. As will be described herein, system 90 enables switch 11 to communicate with PC 25 in accordance with, optionally, the half-duplex 10BaseT Ethernet standard. The processing performed by switch 11 is well known. Switch 11 optionally, but preferably, is a conventional 24-port 10BaseT Ethernet switch.

Telephone exchange 10 receives or is connected to or with outside lines 50 which provide a connection to the public switched telephone network.1Exchange 10, and associated wiring, is typically the only element shown in FIG. 1 that is in place in wiring closet 100. A separate twisted pair cable 56a, 56b, 56c generally runs to each of the respective guest rooms, 21a, 21b, 21c, providing telephone service in a standard manner.

An exemplary system 90 in accordance with the present invention can include a standard switch 11 (that complies with IEEE 802.3), and router 13. Router 13 can connect in series between switch 11 and a point of access 14 to a source of information. Although the Internet 52 is shown as the source of information, the present invention can be used to connect to any source, i.e. a video serve. Router 13 can operate on the virtual addresses that are encoded in each packet of data sent by PC 25 and/or switch 11. The virtual addresses direct the signals transmitted from the Internet 52 to the correct through port 17a, 17b, 17c on switch 11. Any standard number of ports can be utilized in conjunction with switch 11 and adapter box 12.

Filter junctions 5a, 5b, and 5c can be placed in series with the telephone wires 54a, 54b, 54c respectively leading from exchange 10 to rooms 21a, 21b, 21c. In operation, the combination of twisted pair 55c and 56c can be viewed as a single transmission line, although there may be two or more physically distinct components separated by, for example, junction 5c. Filter junctions 5a, 5b, and Sc are preferably placed in the portion of the wiring that runs through wiring closet 100, as shown in FIG. 1.

Adapter box 12 can be connected between switch 11 and junctions 5a, 5b, and 5c. Switch 11, as shown, includes three standard Ethernet ports 17a, 17b, 17c. According to the Ethernet standard, each port 17a, 17b, 17c includes a “receive side” 17d for reception of signals and a “transmit side” 17e for transmission of signals. To connect with these ports, adapter box 12 can include an adapter circuit 6a, 6b, 6c, respectively for each port 17a, 17b, 17c on switch 11. The adapter circuits 6a, 6b, 6c can include a port with a “receive side” 6e for receiving signals, and a “transmit side” 6f for transmitting signals. The receive side 6e can be connected, using a single twisted pair, to the “transmit side” 17e of the corresponding Ethernet port 17a, 17b, 17c on switch 11. Similarly, the transmit side 6f can be connected, using a single twisted pair, to the receive side 17d of the corresponding Ethernet port 17a, 17b, 17c on switch 11.

Each adapter circuit 6a, 6b, 6c includes a respective port 6f (shown on adapter 6c) for respectively connecting to a third twisted pair 55a, 55b, 55c, over which signals can be transmitted and received. Twisted pair 55a, 55b, 55c connect between the respective third port 6f and a port on the respective filter junction 5a, 5b, and 5c.

With reference to FIG. 1, the following exemplary guidelines can be used to connect PC 25 to adapter 23 and other elements of system 90:

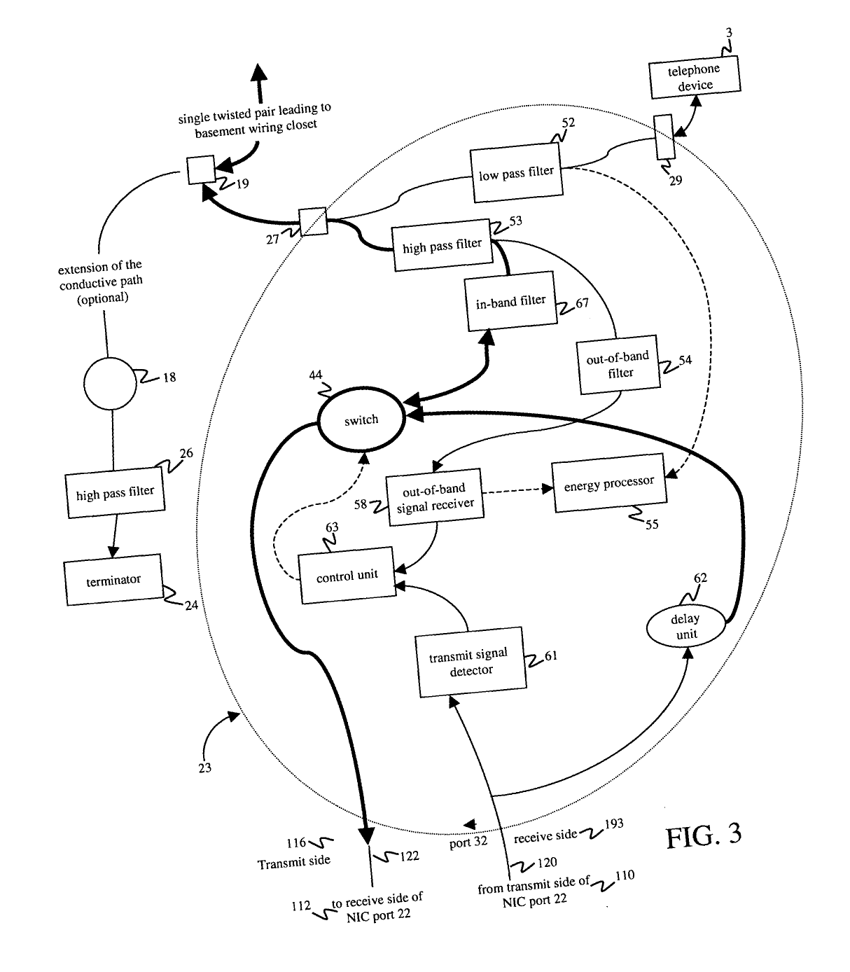

a) If telephone 3 is directly connected to jack 19, the plug of telephone 3 is removed from jack 19 and is reconnected to port 29 on adapter 23. Port 27 of adapter 23 is then connected to jack 19, using a twisted pair. As shown in FIG. 3, a path can be established between telephone 3 and the twisted pair that includes low pass filter 52. NIC 22 used in conjunction with PC 25 is connected to port 32 on adapter 23 to establish a conductive path over which ordinary 10BaseT Ethernet signals can be transmitted back and forth between PC 25 and adapter 23.

b) If adaptor 23 is connected before the end of the telephone line, such as at jack 19, high pass filter 26 and terminator 24 are preferably connected downstream of the final jack, which in this case is jack 18. Filter 26 and terminator 24 prevent reflections of high-frequency signal energy from the end of twisted pair 56c. Alternatively, a low pass filter 28, whose cutoff frequency is above voiceband and below the lowest frequency used by Ethernet signals, can be spliced in series with the twisted pair 56c, preferably between jack 18 and jack 19, which causes adapter 23 to effectively become the end of the twisted pair 56c for signals above voiceband frequency.

c) If a telephone 4 is connected to a jack, such as jack 16, to which adapter 23 is not connected, then low pass filter 28 is preferably connected in series between telephone 4 and jack 19. Low pass filter 28 prevents telephone 4 from affecting high frequencies. Low pass filter 28 preferably connects at a point that is relatively close to the junction with the main conductive path (e.g., near jack 16). Connecting at a point near the junction will reduce the reflection of signal energy that would otherwise degrade the communication between adapter 23 and adapter box 12. Further, in order to reduce the influence of reflections, the distance between the junction and the point of connection should be relatively short. If telephone 4 is not connected, but a branch 29 exists, low pass filter 28 should still be utilized to mitigate the effect of reflections.

PC 25 could communicate directly with switch 11 if they were connected by a cable consisting of two twisted pairs and having a length of 330 feet or less, in accordance with the Ethernet standard. Adapter 23 and adapter circuit 6c are provided to allow PC 25 to communicate with switch 11 in accordance with the Ethernet standard over a single active twisted pair wire that can be at least 600 feet in length. As a result, adapter 23 and adapter circuit 6c can be used to establish communication between between a room 21a and wiring closet 100 when they are separated by a distance of between 330 feet and aproximately 600 feet.

Advantageously, the processing performed by adapter 23 requires a realtivelty small amount of power. As a result, sufficient power can be derived from either the data signals sent from PC 25, the above-voice band signals transmitted from wiring closet 100, or from the telephone signals transmitted from telephone exchange 10. The result is that there is no longer a need to provide and connect a power supply in rooms 21a, 21b, 21c.

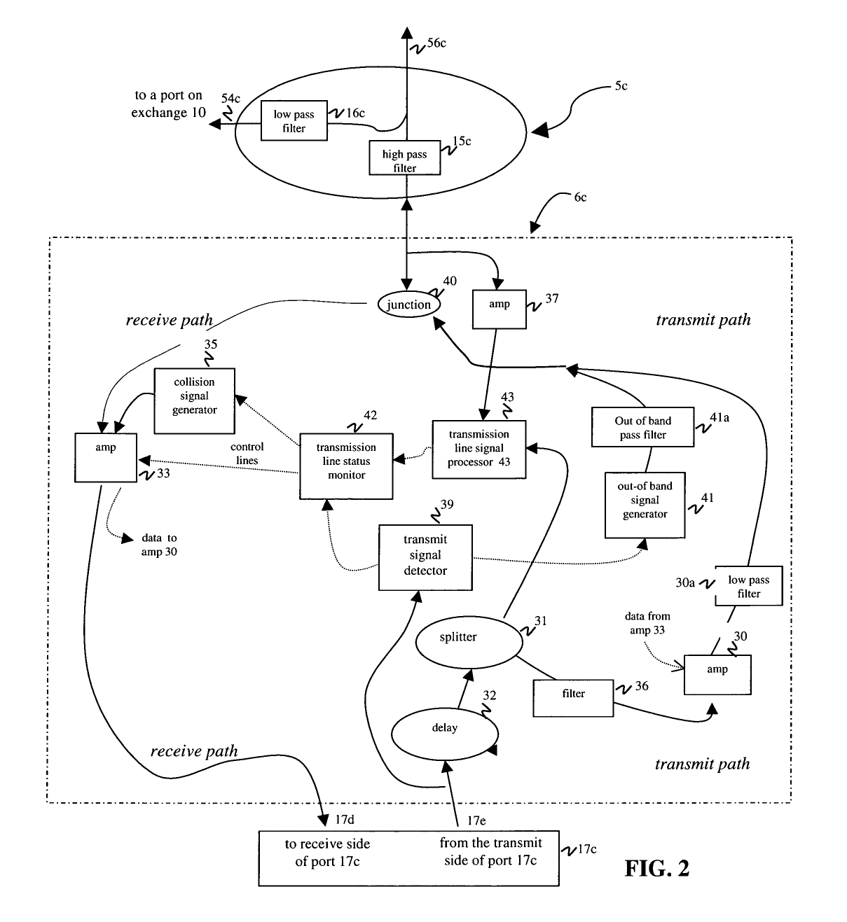

Adapter circuit 6c amplifies the signal transmitted by switch 11 before the signal is transmitted to room 21c. Adapter circuit 6c can also amplify signals transmitted from room 21c that pass through high pass filter 15c, shown in FIG. 2. The amplification advantageously allows the transmission distance to exceed the Ethernet standard of 330 feet.

FIG. 2 is an exemplary embodiment of a block diagram of adapter circuit 6c and filter junction 5c. Adapter circuits 6a and 6b shown in FIG. 1 can be the same as adapter circuit 6c. Filter junctions 5a and 5b can be the same as filter junction 5c. Twisted pair 54c leading from filter junction 5c is shown passing through low pass filter 16c, and twisted pair 55c leads through high pass filter 15c. Low pass filter 16c presents a high impedance to signals having energy concentrated above the telephone voiceband (frequencies below approximately 5 KHz), and high pass filter 15c presents a high impedance to signals having energy is concentrated at frequencies below the telephone voiceband. The filtering blocks telephone signals from being transmitted to adapter circuit 6c, and blocks signals at frequencies above the voiceband from being transmitted to telephone exchange 10. Signals in both frequency ranges, however, can be transmitted over twisted pair 56c (and 56a and 56b).

The processing performed by adapter circuit 6c is now described. Because they are expressed at frequencies above voice, data signals transmitted over twisted pair 55c, 56c pass through high pass filter 15c and junction 40 to amp 33. Amp 33 transmits these signals to amp 30. Amp 30 and out-of-band-signal generator 41 do not substantially affect data signals, since low pass filter 30a and out of band pass filter 41 a present a high impedance to the frequencies used by the data energy transmitted from junction 40.

Amp 33 is normally in an active state, and it will amplify signals transmitted over twisted pair 55c, 56c by adapter 21c (shown in FIG. 3) and provide these signals to the receive side 17d of port 17c. The amplification should be such that the received signal can be detected by switch 11 in accordance with the Ethernet standard. It is also preferable that amp 33 adjust the strength and spectral tilt of the signal caused by the extra attenuation of the high frequencies, vis-a-vis the low frequencies, during transmission across twisted pair 55c, 56c.

Amp 30 can also adjust the level and spectral tilt of signals that it transmits over line 56c to room 21c. The compensation that amp 30 applies should be substantially the same as the compensation provided by amp 33, because they operate on signals that have transmitted over the same twisted pair. As a result, estimates of the line 55c, 56c attenuation and/or spectral tilt can be transmitted from amp 33 to amp 30, as indicated in FIG. 2.

Signals transmitted from the transmit side 17e of port 17c are transmitted to both transmit signal detector 39 and delay element 32. Detector 39 examines its input for the presence of signals and notifies transmission line status monitor 42 whenever it detects them. In response, detector 39 can instruct amp 33 to shut off and present a high impedance at its input. Meanwhile, the transmitted signal passes through delay element 32, splitter 31, amp 30, low pass filter 30a, junction 40, and onto the transmission line 55c, 56c leading to room 21c. The signal is also transmitted to amp 33 from junction 40. However, because signals output by amp 30 are delayed by delay 32, they reach detector 39 before reaching amp 33. If detector 39 and monitor 42 respond fast enough, amp 33 can be disabled before signals from the transmit side 17e port 17c arrive thereat, thereby preventing those signals from being received at the receive side 17d of port 17c.

In one or more embodiments of the invention, a second signal can be added to the signal from port 17c. This accompanying signal can be created by out-of-band signal generator 41, and expressed at frequencies other than those used by Ethernet signals transmitted by port 17c. The two signals can be multiplexed together by filters 30a and 41a before they are transmitted through junction 40 and onto line 55c, 56c. The out-of-band signal can be used by adapter 23 for two different purposes, as will be described herein.

In the two station configuration of NIC 22 and port 17c, a collision can occur if both NIC 22 and port 17c begin transmitting at approximately the same time. If either NIC 22 or port 17c start transmitting, for example, only 1 microsecond before the other, the first signal will have traveled nearly 600 feet and will therefore be received by the companion device before that device begins to transmit. One microsecond is the time it takes to transmit approximately 10 bits. Because Ethernet devices do not transmit when they are receiving signals, collisions in system 90 are not possible unless both devices start transmitting within 1 microsecond of each other (assuming an approximate length of 600 feet for line 56c).

In view of the 1 microsecond transmission window, collisions are not likely to occur within system 90. Furthermore, the Ethernet standard provides for Ethernet systems to sufficiently manage undetected collisions. If the occurrence of undetected collisions is sufficiently infrequent, as is the case with system 90, the undetected collisions will not significantly degrade communications. Accordingly, an embodiment pf the present invention can operate without the use of collision detection.

Nevertheless, two processes by which adapter circuit 6c can detect and manage signal collisions is now described. As used herein, a occurs when signals arrive at the receive side 17d of an Ethernet port at the same time signals are being transmitted from the transmit side 17e.

Because communication to each room (e.g., room 21c) in system 90 takes place over a single transmission line (e.g., line 55c, 56c), it can be difficult for adapter circuit 6c to determine if a signal is arriving at the same time port 17c is transmitting signals. Signal processor 43 can detect arriving signals under these circumstances. In one embodiment, processor 43 receives the signals transmitted from both splitter 31 and amp 37. Amp 37 can connect to transmission line 55c, 56c using a high impedance, in order to derive the signal without loading line 55c, 56c. Because the signal from amp 37 represents the summation of both the signal transmitted from guest room 21c and the signal transmitted by amp 30, processor 43 is able to provide an estimate of the magnitude of the signal transmitted from room 21c. In an embodiment, processor 43 can determine the magnitude of the signal by subtracting a weighted version of the signal transmitted by splitter 31 from the signal derived from transmission line 55c, 56c, thereby leaving only the signal from the room 21c. When the strength of this estimated signal is sufficiently greater than zero, processor 43 concludes that a signal is being received, and notifies transmission line status monitor 42.

In a second embodiment, the signal transmitted from port 17c is passed through filter 36, which can remove part of the signal energy within a very small segment of the spectrum. Filter 36 can be a narrow band ceramic filter having a frequency of approximately 10.7 MHz. Filter 36 is preferably such that the energy taken from the signal does not significantly affect the ability of a receiver to decode signal information. Processor 43, by contrast, optionally includes an inverse filter at the same band as filter 36. Therefore, when processor 43 detects energy out put from the inverse filter, a signal is necessarily being received from line 56c.

To account for collisions that may occur in system 90, transmission line status monitor 42 controls the process whereby a collision signal is sent to port 17c. In general, when an Ethernet device detects a collision, it stops its transmissions and begins to transmit a “collision signal,” alerting other Ethernet devices on the network that the last signal was not cleanly received and must be resent. Such a signal is sent only when processor 43 indicates to monitor 42 that a signal is transmitted from room 21c via line 55c, 56c, and detector 39 simultaneously indicates that a signal is being transmitted from port 17c. When this occurs, monitor 42 instructs signal generator 35 to create a collision signal of short duration. In response, generator 35 transmits a signal to amp 33 which is relayed to port 17c, thus indicating that a collision is taking place.

Ethernet communication systems can include multiple devices that communicate across a shared conductive path. Under this configuration, signal collisions should be detected at each device. However, with system 90, there are only two stations in each Ethernet “collision domain.” For example, port 17c on switch 11, and PC 25. As a result, a collision at one station will nearly always be accompanied by a collision at the companion station. Furthermore, system 90 will account for collisions regardless of whether the first, the second, or both devices detect the collision. As a result, placement of a collision detection mechanism in adapter circuit 6c is sufficient, even if adapter 23 is not equipped with such a mechanism. However, a collision detection mechanism for adapter 23 is described below. It is preferred, however, to detect collisions in adapter circuit 6c, as described above.

The detection of collisions by adapter 23 is now described. Out-of-band signal generator 41 is an optional component that creates a signal that can be multiplexed together with Ethernet signals transmitted from port 17c. The signal created by out-of-band generator 41 (FIG. 2) is not utilized by the Ethernet standard, and is directed to out-of band signal receiver 58, as described above.

Referring now to FIG. 3, out-of-band signals on transmission line 56c, 59 can be transmitted to out-of-band signal receiver 58 independent of the setting of switch 44. In particular, these signals can be be transmitted to out-of-band signal receiver 58 even when signals are transmitted by NIC 22, and switch 44 is set to connect delay unit 62 to in-band filter 67. As a result, out-of-band signal receiver 58 can detect signals arriving from wiring closet 100.

Out-of-band signal receiver 58 communicates the presence of signals from wiring closet 100 to control unit 63 which, as described above, learns when signals are being transmitted by NIC 22 from detector 61. When control unit 63 learns that signals are received from wiring closet 100 at the same time that signals are transmitted by NIC 22, it sets switch 44 to connect in-band filter 67 with the transmit side 116 of port 32. This allows signals from wiring closet 100 to be received by NIC 22. Because NIC 22 is transmitting at the same time, it will react as a standard Ethernet device does when a collision is detected.

The manner in which signals can be transmitted back and forth between computer 25 and adapter 23 is now described with reference to FIG. 3. NIC 22 includes a port with a transmit side 110 and a receive side 112. Transmit side 110 can connect using a single twisted pair 120 to the receive side 193 of port 32 on adapter 23. The receive side 112 of NIC 22 can connect using a single twisted pair 122 to the transmit side 116 of port 32.

Signals transmitted to receive side 193 continue on to transmit signal detector 61, and delay unit 62. Delay unit 62 can delay the transmission of the signal by approximately 500 nanoseconds, which is approximately the time required to transmit five bits of data. The delayed signal transmits to switch 44.

Switch 44 connects in-band filter 67 to either delay unit 62 or to the transmit side 116 of port 32. Several different known techologies, such as analog CMOS switches (e.g., Analog Devices Corp. part nos. ADG 601 and/or 602) can be used to implement switch 44 in a way that enables it to function on low power.

When switch 44 is set, as described below, to connect delay unit 62 with in-band filter 67, signals from NIC 22 pass through switch 44, delay unit 62, and in-band filter 67 to high pass filter 53, and continue on to transmission line 56c. In-band filter 67 blocks signals outside the band used by the Ethernet standard. Ethernet signals are blocked from alternative paths by low pass filter 52, which passes only voiceband signals, and out-of band filter 54, which blocks Ethernet signals.

Transmit signal detector 61 can monitor the twisted pair 120 over which NIC 22 transmits signals, and notify control unit 63 when signals are transmitted from NIC 22. Upon detecting signals, control unit 63 can signal switch 44 to connect in-band filter 67 to delay unit 62. Optionally, as part of the same operation, switch 44 can break the connection between in-band filter 67 and the transmit side 110 of port 32. Because signals from NIC 22 arrive at detector 61 before they pass through delay unit 62, the control signal from control unit 63 can reach switch 44 before signals transmitted from NIC 22. As a result, switch 44 has time to react, if necessary, and to assume the setting whereby signals from the transmit side 110 of NIC 22 are transmitted to line 120.

The manner by which NIC 22 can receive signals is now described. With reference to FIG. 3, path 56c, 59 leading from wiring closet 100 reaches port 27. Voiceband signals are tranmitted on path 56c, 59 to telephone device 3, but are blocked from being transmitted to other elements in adapter 23 by high pass filter 53. Signals transmitting on path 56c, 59 at frequencies above the voiceband are substantially blocked from port 29 by low pass filter 52, but can be transmitted through high pass filter 53.

The above-voice band signals include the Ethernet data signals and, under certain embodiments, certain signals created by out-of-band signal generator 41 (e.g., signals that are expressed outside the frequencies specified in the Ethernet standard). Signals pass through in-band filter 67 to switch 44. As previously described, if signals are not being transmitted by NIC 22, control unit 63 will set switch 44 to connect in-band filter 67 with the transmit side 110 of port 32. At the same time, this breaks the connection between in-band filter 67 and delay unit 62. Ethernet signals will continue on to the receive side 112 of NIC 22, thereby completing the connection between port 17c and NIC 22.

One method of providing power for adapter 23 is to derive power from the out of band signals generated by out-of-band signal generator 41 (FIG. 2). For example, out-of-band signal generator 41 may create a substantially pure harmonic at a frequency of, for example, 1 MHz. As described above, this signal will accompany the Ethernet signals from port 17c (FIGS. 1, 2). The 1 MHz signal can pass through out-of-band filter 54, but will be blocked by filter 67.

The 1 MHz signals can be transmitted to out-of-band signal receiver 58, which can detect the presence of the out-of-band signals for the purposes of collision detection. Out-of-band signal receiver 58 can let most of the out-of-band signal energy pass through to energy processor 55, which can store some of this energy and make it available to switch 44, transmit signal detector 61, out-of-band signal receiver 58, and control unit 63 (the active components of adapter 23).

Adapter 23 can also be powered from voiceband signals. For example, energy processor 55 connects to path 118 between filter 52 and port 29, thereby tapping into the direct current component of voiceband signals. When energy processor 55 derives energy from path 118, it is not necessary that energy processor 55 be connected to receiver 58. Energy processor 55 can tap sufficient power from line 118 to satisfy the demands of the active components of adapter 23, without substantially affecting operation most telephone systems.

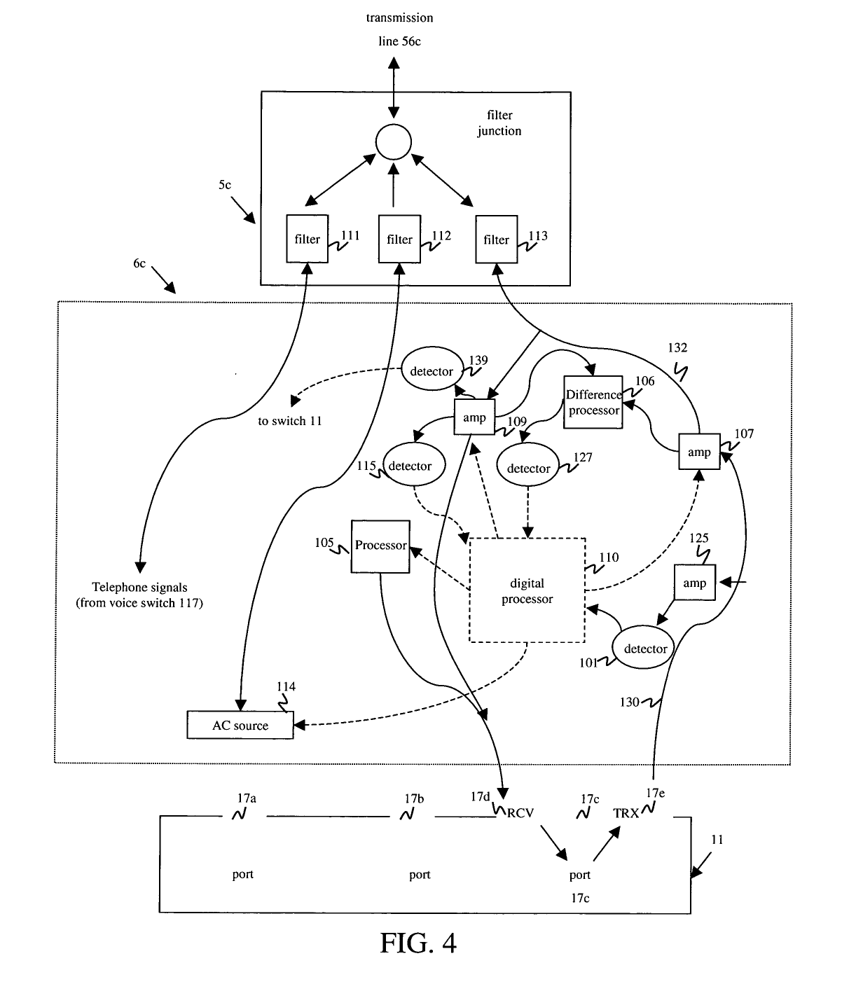

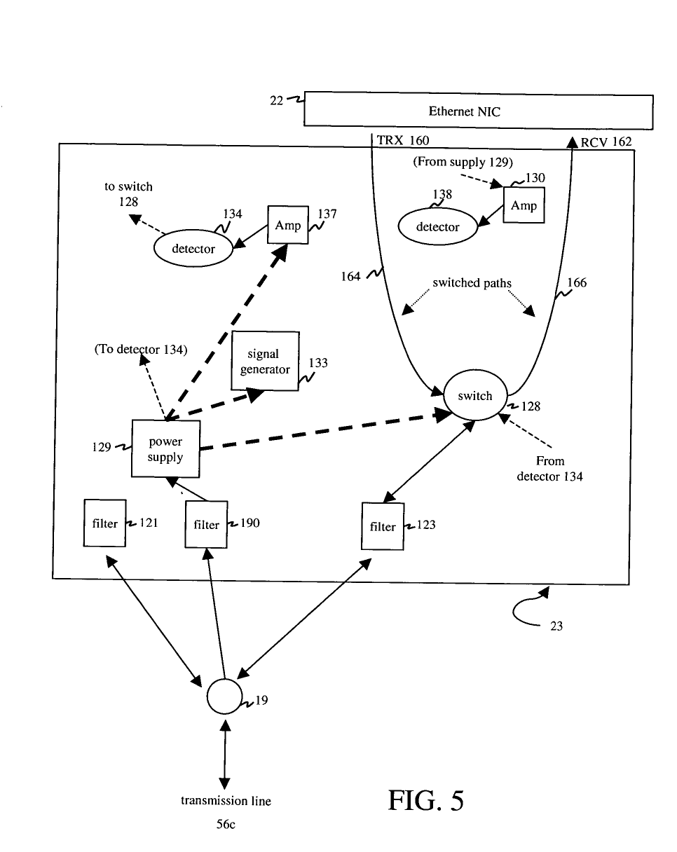

FIGS. 4 and 5, taken together, show another embodiment of the present invention. In particular, FIG. 4 shows an embodiment of the signal processing in wiring closet 100.

FIG. 4 shows AC source 114, which can be used to provide certain elements of adapter 23 with power. Adapter 23 transmits signals from NIC 22 onto line 56c, and receives signals from line 56c that it provides to NIC 22. It is shown in FIG. 5 and is described later on.

AC source 114 can provide power in the form of a harmonic that is transmitted across line 56c at frequencies below the lowest 10BaseT frequency and above the voiceband frequencies. Adapter 23 elements preferably have a very low power requirement, and thus can advantageously utilize a harmonic instead of DC power.

Telephone signals from telephone exchange 10 transmit through filter 111 and onto line 56c. Filter 111 presents a high impedance to signals above the voiceband, thereby preventing loading of the data and AC power signals.

Signals transmitted from transmit side 17e of port 17c follow path 130. These signals are amplified by amp 107, and continue through filter 113 and onto transmission line 56c. The gain of amp 107 can be set so that the signal will have an energy level, after 600 feet, that satisfies, for example, the minimum threshold specified by the Ethernet standard for a 10BaseT receive port.

Filter 113 can be a passive high pass filter that presents a high impedance to energy at the frequency used by the AC source 114 and also to lower frequencies, including voiceband frequencies. In at least one embodiment, AC source 114 can use a frequency of 40 KHz.

Amp 125 and detector 101 can together detect when signals are transmitted from transmit side 17e of port 17c. Amp 125 can connect at a high impedance to path 130 that connects between the transmit side of port 17c and the input to amp 107. This enables amp 125 to derive a copy of the transmitted signal without substantially affecting signal transmission over line 130. Amp 125 passes this signal to detector 101, which notifies digital processor 110 when it detects energy that is transmitted to amp 107. A detection of energy transmitted to amp 107 is also an indication that the same energy is being transmitted on line 56c.

The binary signal from detector 101 is one of several such signals that can be transmitted to digital processor 110, which can provide the logic that can be used to operate and/or facilitate operation of adapter circuit 6c. Such a processor is sometimes called “glue logic.”

In an embodiment of the invention, auto-negotiation pulses do not prompt detector 101 to indicate to digital processor 110 that it has detected energy. As defined in the Ethernet standard, auto-negotiation is an optional feature for 10 and 100 Mbps twisted-pair Ethernet media systems that enables devices to negotiate the speed and mode (duplex or half-duplex) of an Ethernet link. Twisted-pair link partners (e.g., NIC 22 and port 17c) can use auto-negotiation to figure out the highest speed that they each support, for example, as well as automatically setting full-duplex operation if both ends support that mode. They also use these pulses, at regular intervals, to indicate that a station is “active.” Thus, auto-negotiation pulses do not really provide an indication of a transmission of data, and detector 101, optionally, can ignore them.

Amp 109 connects, preferably at a relatively high impedance, to connection 132 which connects between amp 107 and filter 113. Signals transmitted from NIC 22 towards port 17c are not affected by amp 109. Rather, they continue on to amplifier 107, which presents a matched impedance to signals presenting at its output, thereby terminating the signal. Amp 109 accordingly recovers a copy of the high-frequency energy, (e.g., energy at frequencies above the frequency of AC source 114) transmitted by NIC 22 onto line 56c.

Amp 109 transmits a copy of this signal to detector 115. The amplification provided by amp 109 ensures that the level of the signal from amp 109 satisfies the Ethernet standard. If detector 115 detects that the signal from amp 109 exceeds a particular threshold, it provides a signal to processor 110 indicating that NIC 22 is transmitting. Detector 101 has also signaled processor 110, indicating whether or not port 17c is transmitting a signal. As a result, if detector 101 does not detect while detector 115 does detect, processor 110 knows that signals are being transmitted towards port 17c. Processor 110 can then instruct amp 109 to transmit an amplified copy of its signal to the receive side 17d of port 17c.

If the length of line 55c, 56c is known, amp 109 can optionally be set to output signals at a level that accounts for signal attenuation. Preferably, amp 109 includes an “automatic gain control,” that can automatically adjust the level of the signal it transmits to port 17c. To do this, amp 109 can measure the level of the signal from line 56c, and adjust that signal to at least meet the level established by the Ethernet standard that is required for the receive side 17d of port 17c to recognize a signal.

The signal can also be adjusted to compensate for distortion encountered while transmitting across line 56c. Distortion can result because of the greater rate of attenuation experienced by the higher frequencies as the signal is transmits line 56c. If the length of line 55c, 56c is known, the differences in attenuation between high and low frequencies can be determined, and amp 109 can also be set to correct and/or compensate for these differences.

For example, amp 109 can measure the differences in signal level between high frequencies and low frequencies, and apply commensurately greater amplification to high frequencies relative to low frequencies. Preferably, amp 109 can be set to preserve the relative phase of the various frequencies of the signal. If the length and transmission characteristics of line 56c do not change over time, the adjustments of amplitude and phase need only be computed once.

Processor 105 can optionally create auto-negotiation pulses specified by the Ethernet standard that are continuously or substantially continuously transmitted to the receive side 17d of port 17c. The form of these pulses can signify the Ethernet modes under which the device issuing the pulses can operate. Processor 105 can create auto-negotiation pulses, for example, that will indicate to port 17c that its “companion” station can operate only tin 10BaseT half-duplex mode. This will cause port 17c to operate in 10BaseT half-duplex mode, and will also cause port 17c to transmit the same auto-negotiation pulses through amp 107, line 56c, and on to NIC 22. This will force that device to operate in 10baseT half duplex, thereby cause all of system 90 to operate in, for example, a 10BaseT half duplex manner.

When signals are transmitted to port 17c, processor 110 can signal processor 105 to suspend the transmission of link pulses. Otherwise, these link pulses could interfere with reception by the receive side of port 17c.

The mechanism whereby processor 110 also can detect collisions is now described. As described in the 802.3 standard, a collision occurs when a port cannot detect a signal that presents at its receive port because it is transmitting a signal through its transmit port.

Collisions can occur as port 17c begins to transmit a signal. Such a collision will occur if signals transmitted from NIC 22 are passing amp 109 as port 17c begins transmitting. Under other circumstances, two signals may be on line 56c, but amp 109 may not immediately detect them. The maximum delay in collision detection generally occurs when the signal transmitted from port 17c reaches NIC 22 just before NIC 22 begins to transmit. When NIC 22 begins to transmit, signals from port 17c and NIC 22 will be present on line 56c near NIC 22. The signal from NIC 22 will ultimately reach amp 109, creating a situation where both signals contribute to the energy on the line at the point where amp 109 takes a measurement.

The time elapsed, under these circumstances is the time it takes for energy to transmit across line 55c, 56c in both directions. This is related to the speed of electromagnetic energy across a wire, which is approximately 200 million meters per second, and the Ethernet 10BaseT data rate, which is 10 million bits a second. Given those two quantities, signal energy transmits approximately 20 meters, or 60 feet per bit. For transmission lines of 600 feet, the transmit side of port 17c will output 20 bits (i.e., a “round trip”) before digital processor 110 detects the collision. This is equivalent to 2 microseconds. The importance of this number will be made clear later on.

Focus now returns to the way in which collisions are detected is now described. As indicated above, detector 101 notifies processor 110 when switch 11 is transmitting. At that point, amp 107 can create a duplicate of this signal. The duplicate signal can be transmitted to difference processor 106. Amp 109 can also provide a signal to difference processor 106. This signal can be an unamplified version of the signal detected on line 56c. Difference processor 106 creates the difference between these two signals, and the difference signal is passed to detector 127.

When PC 25 is not transmitting, the difference should be steady and approximately equal to zero. Detector 127 signals processor 110 if a relatively sudden increase in the computed difference is detected. If such an increase occurs while detector 101 detects a transmission at port 17c, this indicates that signals are being simultaneously transmitted and received at port 17c, thus indicating a collision.

When a collision occurs, stations on each end of the transmission line (e.g., PC 25 and switch 11) must learn that a collision has occurred prior to completing their on-going transmission. Otherwise, a station (e.g., PC 25) will react as if the other station (e.g., switch 11) has received its transmission correctly when, in fact, the other station has not been listening. Under the Ethernet standard, such a “miscommunication” will result in substantial communication delays, while the two sides determine their respective discrepancies.

Port 17c learns of a collision as follows. When detector 127 informs digital processor 110 that two signals are on line 56c, digital processor 110 can cause or instruct processor 105 to suspend passing auto-negotiation pulses to the receive side 17d of port 17c. Instead, digital processor 110 will direct processor 105 to transmit a signal, that preferably satisfies the Ethernet standard, to the receive side 17d of port 17c. This will cause port 17c to decide that it is both receiving and transmitting, thereby causing that port to decide that a collision has occurred.

To alert NIC 22 that a collision has occurred, processor 110 can utilize AC source 114, which can operate at a frequency of 40 KHz. AC source 114 can transmit its signal through filter 112, which can be a band pass filter that presents a high impedance to energy in the voiceband and also to energy at 10BaseT frequencies. Processor 110 can use AC source 114 for communication by instructing or causing AC source 114 to reduce its power level for a short time, preferably one cycle. Such a reduction can be detected by adapter 23, thereby communicating that a collision is taking place.

The collision alert process takes place before switch 11 and NIC 22 complete their respective transmissions. The 10BaseT Ethernet standard specifies a minimum transmission length of 512 bits. The process of detecting a collision and reporting the collision to each end must therefore occur within the time it takes to transmit 512 bits.

The first source of delay is the time it takes for energy from NIC 22 and switch 11 to reach amplifier 109. As described above, NIC 22 may begin its transmission just before a transmission from port 17c arrives at NIC 22. The time elapsed under these circumstances is approximately equal to the time to transmit across line 56c in both directions. For transmission lines of 600 feet, as previously discussed, the transmit side 17e of port 17c will output 20 bits (i.e. a “round trip”) before digital processor 110 learns of the detection.

A second source of delay is the time it takes to detect the single cycle of the 40 KHz sinusoid of AC source 114. The length of this cycle is the inverse of 40 kHz, which is 25 microseconds. During this time, 250 bits of data can transmit. Given the 20 bit times required to detect the collision, a total of 512-250-20 or 232 bit times remain during which a collision can be indicated.

FIG. 5 shows an exemplary embodiment of adapter 23, and transmit port 160 (TRX) and receive port 162 (RCV) of NIC 22. As shown in FIG. 1, adapter 23 can be connected between PC 25 and jack 19.

Signals transmitted from port 17c are transmitted through filter 123 to switch 128, which is normally set to connect to receive port 162, thereby directing signals from line 56c towards that port. Switch 128 is normally set to be disconnected from port 160.

Energy for the operation of the electronics within adapter 23 can be provided by AC source 114, as previously described. Energy from AC source 114 is transmitted by line 56c through bandpass filter 190, and on to power supply 129. Band pass filter 190 has the same or substantially the same characteristics as filter 112. Power supply 129 can distribute power to amp 137, switch 128, detector 134, and signal generator 133. Using known techniques, power supply 129 can also derive sufficient power from the voice band signals, as described earlier.

Finally, telephone signals from telephone exchange 10 transmit through filter 121 and onto line 56c. Filter 121 presents a high impedance to signals above the voiceband, thereby preventing loading of the data and AC power signals.

Amp 137 connects to line 164 leading from transmit port 160 to switch 128. Amp 137 optionally but preferably has a high impedance, so it can detect signals without substantially affecting them. The beginning of a transmission from NIC 22 can be detected when amp 137 receives energy over a period of time that, for example, is longer than that of an auto-negotiation signal. Amp 137 transmits the received signal to detector 134, which can signal switch 128 to break its connection to receive port 162 and to connect, instead, to transmit port 160. Adequate switching can also be achieved whereby switch 128 normally connects to transmit port 160, and switches when it detects arrival of signals from switch 11.

As described earlier, NIC 22 must be able to determine when it has missed receiving a packet of data because it was transmitting at the time. This is called a collision. When an Ethernet station has established Ethernet communication with just one other station, however, it is very unlikely for a collision to occur at one station. As a result, the great majority of collisions can be detected if a detection mechanism is provided at just one station.

A way in which the ports of switch 11 learn of a collision was described earlier. The station left without a collision detection mechanism, however, must learn of a collision from the alternative station, e.g. port 17c. During a collision situation, however, signals will be transmitting from NIC 22, switch 128 will be connected to port 160, and no signals can be received at port 162. As a result, NIC 22 cannot learn of a collision through port 162.

Accordingly, collisions detected at switch 11 are be communicated to adapter 23 by a temporary reduction in the level of AC source 114 (FIG. 4). This reduction can be detected by power supply 129. In response to AC source 114, power supply 129 can signal switch 128 to switch the connection to receive port 162, thereby directing signals from line 56c into receive port 162. The switch will create a situation where signals are simultaneously being transmitted to receive port 162 and from transmit port 160, a situation NIC 22 will recognize as a collision.

Upon recognizing a collision, NIC 22 will, according to the Ethernet protocol, stop transmitting its packet and will instead transmit a 48 bit jam signal. After this, switch 128 flips to connect, for example, receive port 162 to line 56c. System 90 can remain quiescent until NIC 22 again transmits or receives a transmission.

There is a scenario that is likely to cause collisions in an Ethernet network consisting of only two stations (e.g., NIC 22 and switch 11). These types of collisions occur when data (e.g., a packet) is being transmitted on line 56c and NIC 22 and switch 11 are waiting to send a packet. According to the Ethernet standard, each station must wait 9.6 microseconds before transmitting its packet. This is the time required to transmit 96 bits of data, and is called the Inter Frame Gap (IFG). If transmission line 56c is not too long, the end of the packet that is already transmitting is detected by both stations at nearly the same time. Each station can therefore begin its 96 bit “countdown” at approximately the same time, which is likely to create, or cause, a collision. The station that receives the packet already transmitting will detect the “end” of that packet later, so it will begin transmitting the follow-on packet later. This, however, means that the packets will collide at the end of line 56c closest to the receiving station.

In accordance with an embodiment of the present invention, a solution for eliminating these types of collisions consists of changing the IFG in switch 11 to a value different than 96 bits. The magnitude of the change should preferably be at least as large as the time it takes for a bit to transmit across line 56c. In another embodiment, switch 11 can change the IFG between values that are alternatively higher and lower than 9.6 microseconds. Switch 11 can change the value to the alternate after each packet transmits, making the stations alternate as being the first to end its “countdown” and transmit a packet.

System 90 can also perform, for example, “status monitoring” and “polarity detection.” These functions can be performed by amp 130, signal generator 133, and detector 138. Amp 130 can connect, preferably at a relatively high impedance, to line 166, thereby detecting signals without substantially loading the line. Amp 130 can utilize a portion of the energy associated with signals transmitting on line 166, and transmit the energy to detector 138. When such signals are detected, they will be the only ones transmitted on line 56c, because transmit port 160 is not connected to switch 128. Detector 138 can notify signal generator 133, which has stored energy that can be used to create and apply a pulse, at Ethernet frequencies, onto line 56c.

Referring again to FIG. 4, within adapter circuit 6c, detector 139 receives signals transmitted on line 56c by signal generator 133. Detector 139 is such that it can react only to energy in the form of a pulse from generator 133. In response, detector 139 can transmit the status of adapter 23 to switch 11 through a port (not shown) on switch 11. For example, a pulse generated by adapter 23 can indicate that power is being supplied to and used by adapter 23.

Detector 139 can also detect the polarity of the pulse. The polarity is negative or positive relative to one of the leads of line 56c. Detector 139 can utilize one or more of several known techniques to determine polarity. Detector 139 can communicate polarity to the same port to which status information has been transmitted. The polarity feature can be used to indicate a polarity mismatch exists.

In one or more embodiments of the invention, The transmission length of system 90 can be further extended if additional power is available in adapter 23. In that case, power supply 129 can drive an amplifier (not shown) that can be placed, for example, between transmit port 160 and switch 128. Preferably, this amplifier can utilize pre-emphasis to partially compensate for the higher rate of attenuation of high frequency signals. An amplifier (not shown) can also be inserted, for example, between switch 128 and the receive port 162 to increase the level of signals at its input above that required by receive port 162. Preferably, this amplifier would also implement equalization, thereby creating the same type of compensation implemented by the amplifier connected to the transmit port.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention. While the foregoing invention has been described in detail by way of illustration and example of preferred embodiments, numerous modifications, substitutions, and alterations are possible without departing from the scope of the invention defined in the following claims.

Having thus described our invention, what I claim as new and desire to secure by Letters Patent is as follows:

1. A method for communicating over a single pair twisted conductive path, comprising:
applying signals from a transmit port of a 10BaseT Ethernet station onto said conductive path at a first point of connection while presenting a relatively high impedance to signals on said conductive path at frequencies used by ordinary telephone devices,
receiving signals at the receive port of the 10BaseT Ethernet station from said first point of connection to said conductive path while presenting a relatively high impedance to signals on said conductive path at frequencies used by ordinary telephone devices, and
transmitting and receiving telephone signals through a second point of connection to said conductive path while presenting a high impedance to signals above the frequencies used by ordinary telephones, replacing the connection between said first point of connection and said transmit port to said connection between said first point of connection and said receive port whenever no signals are being transmitted from said transmit port and signals are detected on said transmission line, wherein said applying of signals and said receiving of signals occur during non-overlapping segments of time.
